(19) United States
(12) Patent Application Publication
(10) Pub. No.: US 2009/0305520 A1
(43) Pub. Date: Dec. 10, 2009

(54) CONNECTOR

(75) Inventors: Hsin-I Lu, Taipei (TW); Chin-Chung Lai, Taipei (TW); Yi-Chieh Chang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTek Computer Inc., Taipei (TW)

(21) Appl. No.: 12/429,232

(22) Filed: Apr. 24, 2009

(30) Foreign Application Priority Data
Jun. 6, 2008 (TW) 97121087

(51) Int. Cl. H01R 12/00

(52) U.S. Cl. 439/55

(57) ABSTRACT

A connector includes a main body, two fixing arms and a plurality of signal transmission pins. The main body has a socket and an outer wall, wherein the outer wall surrounds the socket. The two fixing arms are connected to two sides of the outer wall for attaching the main body to a circuit board. The signal transmission pins are connected to the outer wall for electrically connecting with the circuit board.

This application claims the benefit of Taiwan application Serial No. 97121087, filed Jun. 6, 2008, the subject matter of which is incorporated herein by reference.

### BACKGROUND OF THE INVENTION

1. Field of the Invention

The invention relates in general to a connector, and more particularly to a USB connector.

2. Description of the Related Art

Nowadays, various electronic devices such as notebook computers, digital cameras, personal digital assistants (PDA), mobile phones, and MP3 players make use of universal serial bus (USB) connector to transmit data and to charge battery. Normally, an electronic device is equipped with more than one USB connector to meet a user's needs.

As the current design of an electronic device is directed towards the trend of slimness and miniaturization, too many USB connectors not only occupy the space in the circuit board but also increase the volume of the electronic device, hence failing to meet the above requirements.

### SUMMARY OF THE INVENTION

The invention is directed to a connector including a main body, two fixing arms and a plurality of signal transmission pins. The main body has a socket and an outer wall, wherein the outer wall surrounds the socket. The fixing arms are connected to two sides of the outer wall for attaching the main body to a circuit board. The signal transmission pins are connected to the outer wall for electrically connecting with the circuit board.

According to the connector of the invention, the signal transmission pins are disposed next to the fixing arms for using the surrounding space of the fixing arms and reducing the space occupied by the connector on the circuit board. Thus, electronic products further meet the requirements of slimness, lightweight, compactness and simplicity.

The invention will become apparent from the following detailed description of the preferred but non-limiting embodiments. The following description is made with reference to the accompanying drawings.

### BRIEF DESCRIPTION OF THE DRAWINGS

FIG. 1 is a diagram showing a connector according to a preferred embodiment of the invention; and

FIG. 2 is a diagram showing the connector in FIG. 1 disposed on a circuit board.

### DETAILED DESCRIPTION OF THE INVENTION

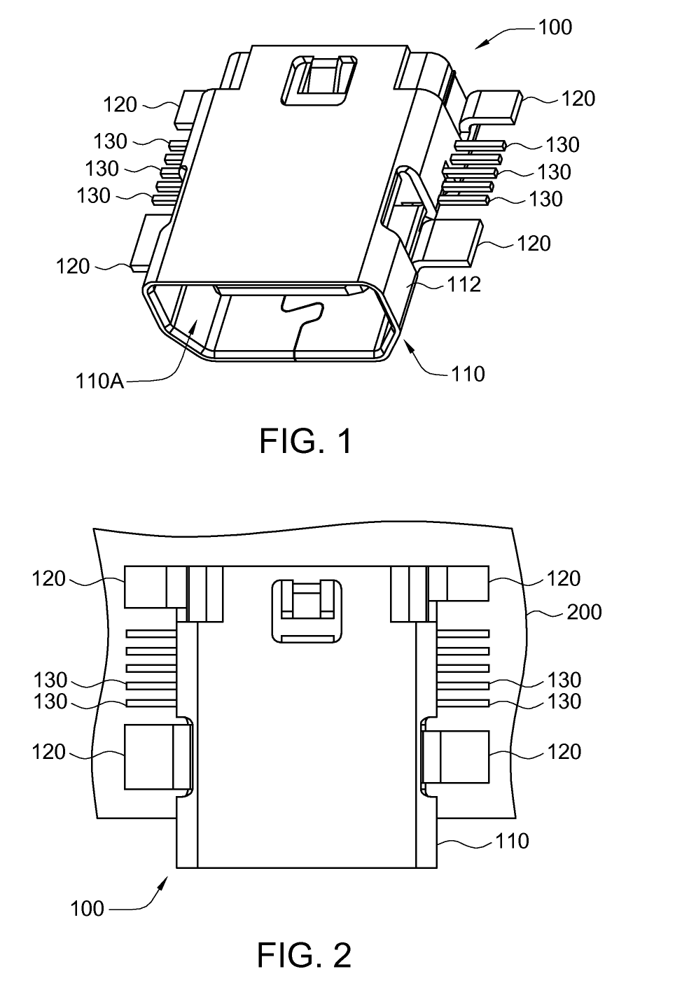

FIG. 1 is a diagram showing a connector according to a preferred embodiment of the invention. The connector 100 includes a main body 110, a plurality of fixing arms 120 and a plurality of signal transmission pins 130. The main body 110 has a socket 110A and an outer wall 112, wherein the outer wall 112 surrounds the socket 110A. Preferably, the fixing arms 120 are symmetrically connected to the outer wall 112 relative to the socket 110A. The fixing arms 120 are extended in a direction away from the outer wall 112 for attaching the main body 110 to a circuit board 200 (shown in FIG. 2). The signal transmission pins 130 are connected to the outer wall 112 and disposed adjacent to the fixing arms 120 for electrically connecting with the circuit board 200.

In the present embodiment of the invention, the connector 100 is a universal serial bus (USB) connector for example. As shown in FIG. 1, the connector 100 in the present embodiment of the invention has four fixing arms 120 that are symmetrically disposed relative to the socket 110A, wherein each side of the two outer walls 112 has two fixing arms 120. Preferably, each Preferably, each fixing arm 120 is extended in a direction perpendicular to the plugging direction of the socket 110A. The fixing arms 120 and the outer wall 112 are integrally formed in one piece, for example.

In the present embodiment of the invention, the signal transmission pins 130 are equally divided into two groups that are symmetrically disposed relative to the socket 110A and connected to the outer wall 120. As the fixing arms 120 are connected to the outer wall 112 and the signal transmission pins 130 are disposed next to the fixing arms 120, the surrounding space of the fixing arms 120 is thus utilized. In addition, as the two fixing arms 120 on the same side of the main body 110 are spaced at an appropriate interval, the signal transmission pins 130 on the same side are disposed between the two fixing arms 120. Besides, the extending direction of the signal transmission pins 130 is substantially the same as that of the fixing arms 120, and the signal transmission pins 130 and the fixing arms 120 are on the same plane.

FIG. 2 is a diagram showing the connector in FIG. 1 disposed on a circuit board. The fixing arms 120 attach the main body 110 to the circuit board 200, and the signal transmission pins 130 are electrically connected with circuit board 200. The fixing arms 120 and the signal transmission pins 130 are fixed on the circuit board 200 by the surface mount technology (SMT) for example. The two fixing arms 120 on the same side of the main body 110 can be spaced by an appropriate interval so that the main body 110 is disposed on the circuit board 200 more firmly and will not come off the circuit board 200 when a plug such as a USB plug is removed from the socket 110A (shown in FIG. 1) abruptly.

With the signal transmission pins 130 being disposed between the fixing arms 120 for adequately utilizing the space between the fixing arms 120, the overall length and volume of the connector 100 will not increase due to the disposition of the signal transmission pins 130 and the fixing arms 120. Thus, the utilization of the circuit board 200 is more flexible when used in other circuits or mechanism.

In the present embodiment of the invention, the number of the signal transmission pins 130 is determined according to the function of the connector 100 and ranges from 2 to 12 for example. In the present embodiment of the invention, the signal transmission pins 130 are equally divided into two groups and are connected to the two sides of the outer wall 112. However, in other embodiments, the signal transmission pins 130 can be disposed on only one side of the outer wall 112 and next to the fixing arms 120 for utilizing the surrounding space of the fixing arms 120.

According to the connector disclosed in the above embodiment of the invention, the signal transmission pins are disposed next to the fixing arms for using the surrounding space of the fixing arms and reducing the space occupied by the connector on the circuit board. Thus, as electronic products are equipped with the connector disclosed in the above embodiment of the invention, the electronic products have larger chance to meet the requirements of slimness, lightweight, compactness and simplicity than those using conventional connectors.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A connector disposed on a circuit board, the connector comprising:
a main body having a socket and an outer wall, wherein the outer wall surrounds the socket;
two first fixing arms connected to two sides of the outer wall for attaching the main body to the circuit board; and
a plurality of signal transmission pins connected to the outer wall for electrically connecting with the circuit board.

2. The connector according to claim 1, further comprising:
two second fixing arms connected to the two sides of the outer wall, wherein the signal transmission pins are located between the first fixing arms and the second fixing arms.

3. The connector according to claim 2, wherein the first fixing arms, the second fixing arms and the signal transmission pins are on the same plane.

4. The connector according to claim 2, wherein the signal transmission pins are equally divided into two groups of signal transmission pins located between the first fixing arms and the second fixing arms.

5. The connector according to claim 1, wherein each first fixing arm is extended in a direction perpendicular to a plugging direction of the socket.

6. The connector according to claim 1, wherein an extending direction of each first fixing arm is the same as that of each signal transmission pin.

7. The connector according to claim 1, wherein the first fixing arms and the outer wall are integrally formed in one piece.

8. The connector according to claim 1, wherein the connector is a universal serial bus (USB) connector.
